(19) United States
(12) Patent Application Publication
(10) Pub. No.: US 2026/0244983 A1
(43) Pub. Date: Aug. 20, 2026

(54) CONTRASTIVE EXPLANATION APPROACH FOR MACHINE LEARNING BIAS DETECTION AND MITIGATION

(71) Applicant: Optum Services (Ireland) Limited, Dublin (IE)

(72) Inventors: Karim Mahmoud Mohamed MOUSTAFA, Dublin (IE); Arjit AGRAWAL, Kildare (IE); Lisa E. WALSH, Dublin (IE); Harutyun SHAHUMYAN, Dublin (IE); Smitashree CHOUDHURY, Dublin (IE)

(21) Appl. No.: 19/058,858

(22) Filed: Feb. 20, 2025

(51) Int. Cl. G06N 20/00; G06F 18/213

(52) U.S. Cl. CPC G06N 20/00; G06F 18/213

(57) ABSTRACT

Various embodiments of the present disclosure provide a contrastive explanation approach for machine learning bias detection and mitigation that improves the functionality of a computer in various aspects. The techniques comprise receiving a target identifier, a feature vector, a prediction, and a target bias feature; determining a comparison feature vector; determining a first contribution score for a first feature, determining a subset of features from the first set of features, determining a set of divergent features, determining a bias indicator, and initiating a computing action.

### BACKGROUND

Traditionally, machine learning models may be trained, using reference data, to make predictions based on correlations learned from the reference data. Thus, the performance of traditional machine learning models depends, at least partially, on a quality of the reference data. In some cases, feature imbalances, and/or other data impurities, may cause a machine learning model to learn biased relationships that output positive and/or negative classifications disproportionately for one feature class. For example, a machine learning model trained using a reference dataset that comprises a disproportionate number of positive classifications for data objects associated with a particular feature class that is irrelevant to the positive classification, may nevertheless learn a correlation between the particular feature class and the positive classification that may bias the machine learning model towards a classification based on irrelevant information. This phenomenon is referred to as machine learning bias and it is a technical challenge in machine learning models that reduces their performance in terms of accuracy.

Bias, in the context of machine-learned outputs, may comprise, for example, more inaccurate outputs (e.g., lower recall) for a subset of input data associated with a particular feature (e.g., a demographic attribute) associated with the input compared to the accuracy of outputs associated with subset(s) of input data associated with different attribute(s) and the same feature, whether that attribute is explicitly defined in the data provided as input to a machine-learned model or not. Additionally, or alternatively, bias in a machine-learned model may comprise a machine-learned model that generates two different outputs for first input data and second input data where the attributes indicated by the first input data and second input data are the same except for an attribute that is different between the first input data and the second input data for one feature.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of a bias detection and mitigation technique in accordance with some embodiments of the present disclosure.

FIG. 5 depicts an operational example of an explainer user interface in accordance with some embodiments of the present disclosure.

FIG. 6 depicts a flowchart diagram of an example machine learning bias detection process in accordance with some embodiments of the present disclosure.

FIG. 7 depicts a flowchart diagram of an example machine learning bias detection process in accordance with some embodiments of the present disclosure.

FIG. 8 depicts a flowchart diagram of an example comparison identifier determination process in accordance with some embodiments of the present disclosure.

### DETAILED DESCRIPTION

In some approaches, machine learning bias may be addressed using algorithmic fairness in which spurious disparities in a machine learning model's outputs are detected and mitigated by retraining the model on new data, modifying the output based to compensate for a measured bias, and/or the like. However, such techniques are limited by inefficient mechanisms for detecting the presence and explaining the source of bias in a machine learning model's outputs. For example, traditional algorithmic fairness approaches comprise group fairness approaches that ensure an output parity at a group level with respect to different grouping of feature classes. Other, more granular, approaches comprise individual fairness approaches that detect bias based on a comparison between an output for a data object with a particular feature class and a set of outputs for related data objects associated with contrasting feature classes. Traditionally, individual fairness approaches provide more granular insights at the cost of time, processing resources, and accuracy. Other technical challenges include a lack of agreement on how to determine related data objects for an individual fairness analysis. These and other challenges with the individual fairness approaches cause the widespread use of group fairness approaches as accuracy and processing efficiency outweigh the explainability benefits of conventional individual fairness approaches.

Various embodiments of the present disclosure provide improved bias detection and mitigation techniques for various machine learned architectures that improve the functionality of a computer with respect to various computing tasks. To do so, the bias detection and mitigation techniques of the present disclosure provide individual and explainable bias mitigation that is configurable for a target data object and/or one or more user defined features. The bias detection and mitigation techniques may use the individual features of the target data object to determine a cohort of related data objects through feature similarity comparisons governed by similarity criteria that are tailored to a particular model being evaluated. In addition, or alternately, the bias detection and mitigation techniques may employ a proxy feature extraction approach to separate the features of the target data object and/or up to each of the related data objects into user defined features, proxies of the user defined features, and/or domain features. Using feature distributions determined for one or more of the feature categories, as well as associated model output distributions of the cohort, the bias detection and mitigation techniques may generate a set of scores that measure model coherence and/or a model trust level for the model under test. These scores, and/or the contextual data for the scores, such as the feature distributions, may be used to enact a granular individual fairness approach without reducing the speed, efficiency, or reliability of machine learning bias detection relative to group fairness approaches. In this manner, the bias detection and mitigation techniques of the present disclosure present a new bias detection technique that combines granularity and explainability of individual bias detection and mitigation with the speed, efficiency, and accuracy of group bias detection and mitigation approaches. This, in turn, enables improved bias detection and mitigation in machine learning models which may result in improved model performance and reduced use of computing resources for a given level of model performance.

More particularly, the bias detection and mitigation techniques of the present disclosure may improve the granularity and/or explainability of bias detections without reducing the speed or accuracy of such predictions by assessing model fairness at an individual level and explaining model decisions using feature divergence (e.g., contrastive explanation) among similar data objects (e.g., nearest neighbors in an embedding space). For example, by classifying features into a set of classes (e.g., user defined features, proxies of the user defined features, domain features), the bias detection and mitigation techniques of the present disclosure may reduce the complexity of bias detection through feature divergence. This, in turn, may enable the use of contrastive explanation techniques that may implement a nested detection scheme in which bias may be incrementally detected in a top-down approach, from categories to granular features. For example, one of these categories could include demographic and a granular feature could include location. By doing so, the bias detection and mitigation techniques of the present disclosure may improve the speed and computing efficiency of bias detection without reducing the granularity and feature-level explainability of individual fairness approaches. Ultimately, the techniques of the present disclosure may improve the detection rate for bias by identifying bias more accurately and with greater particularity, which may improve machine learning reliability in various use cases. For example, the bias detection and mitigation techniques may result in model outputs that have reduced false positive and/or false negative rates, improved recall, an improved receiver-operating characteristic curve (ROC) and/or area under the curve (AUC), and/or the like.

Examples of technologically advantageous embodiments of the present disclosure comprise (i) a particular way of designing bias mitigation techniques that address technical challenges in machine learning and (ii) an improved bias detection structure that is configurable based on a type of target feature without a tradeoff in bias detection performance, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

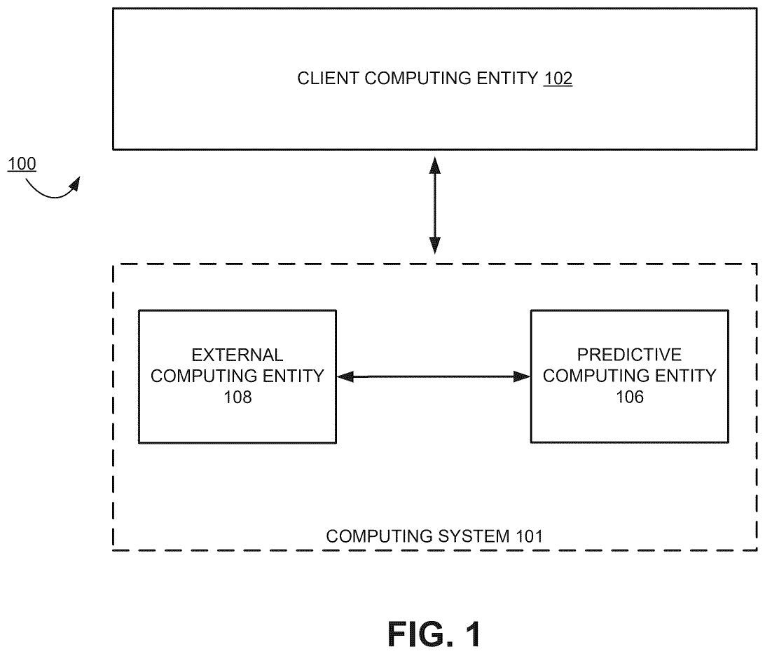

FIG. 1 depicts a block diagram of an example architecture 100 in accordance with some embodiments of the present disclosure. The architecture 100 comprises a computing system 101 configured to receive a request, such as a request that comprises (i) a target identifier and (ii) a target bias feature, and/or the like from client computing entities 102, process the request, and provide a response to the request that identifies the bias indicator to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a differential request handling engine and/or complementary scoring mechanism that may collectively process a request using a modular model ensemble. Some techniques of the present disclosure may adapt traditional models to a cohesive framework, such as the modular model ensemble, for more efficiently handling portions of the request handling process.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate predictions, and provide the predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., request handling, scoring techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may use the datasets such as features vector to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively used by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may use the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be used by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

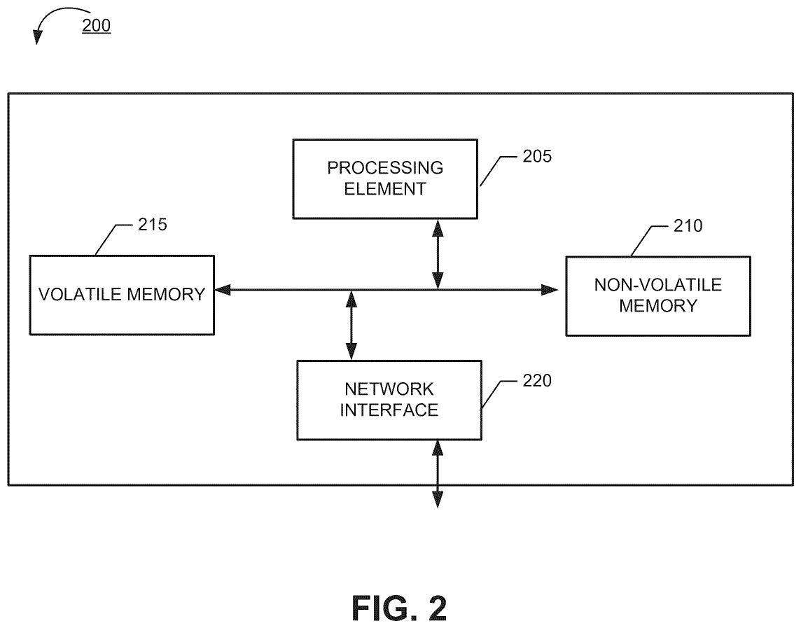

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile memory 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1×(1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

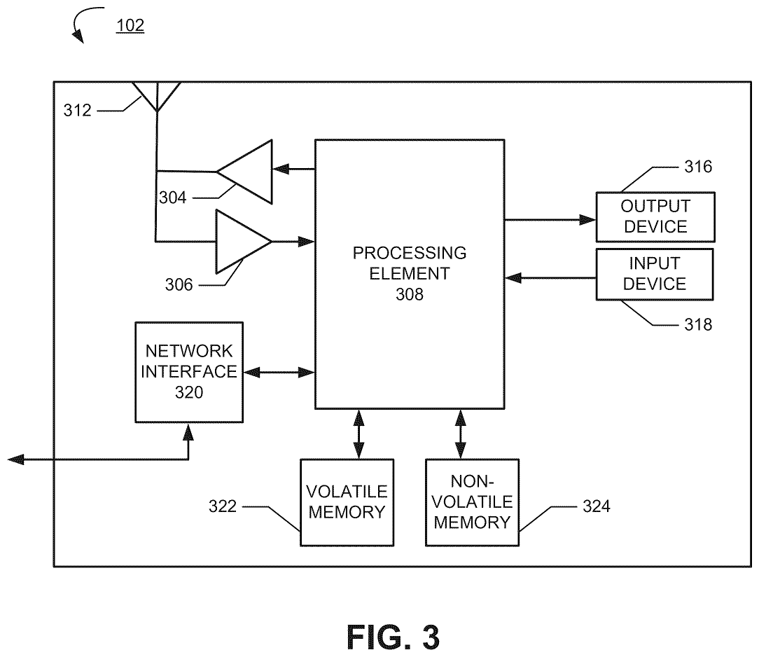

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entities 102, the computing system 101, the predictive computing entity 106, and/or the external computing entities 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to bias detection and mitigation in machine learning models which may result in improved model performance. In particular, systems and methods are disclosed herein that implement a feature divergence ranking to assess model fairness at an individual level and explaining model decisions using feature divergence (e.g., contrastive explanation) among similar data objects (e.g., nearest neighbors). By doing so, the bias detection and mitigation techniques of the present disclosure may improve the speed of bias detection without reducing the granularity and feature-level explainability of individual fairness approaches. This, in turn, may improve the functionality of a computer with respect to various computing tasks, comprising machine learning training and the like.

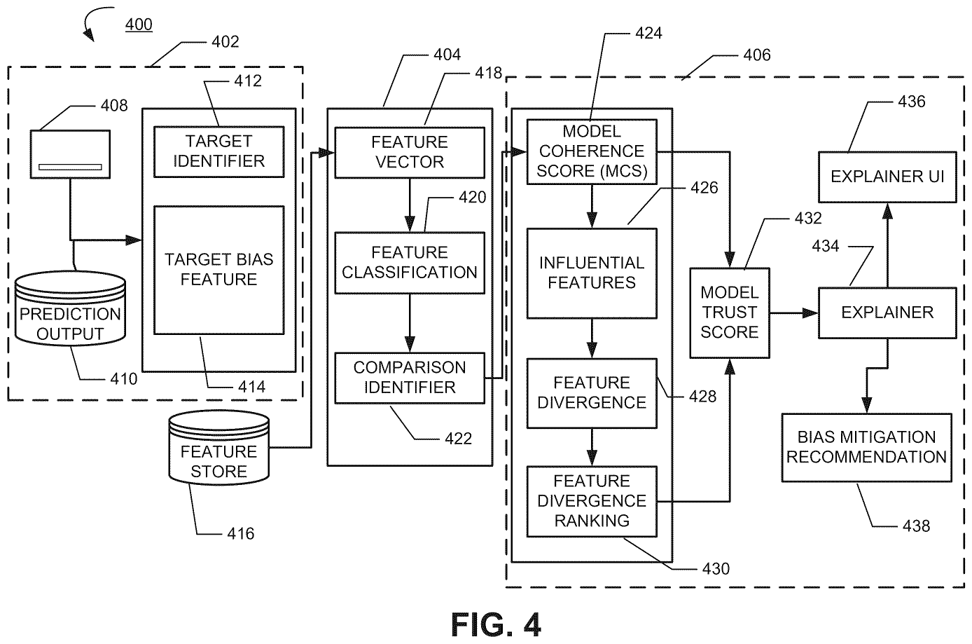

FIG. 4 is a dataflow diagram 400 of a bias detection and mitigation technique in accordance with some embodiments of the present disclosure. As depicted, a bias detection and mitigation technique may implement a feature divergence (e.g., contrastive explanation) among similar members (e.g., nearest neighbors) to assess model fairness with respect to individual features. This, in turn, may improve the performance of computers with respect to various machine learning tasks, including automated decisioning tasks and machine learning training, among others. For example, the bias detection and mitigation techniques of the present disclosure may generate contrastive explanations that clarify why one event occurred in contrast to another (e.g., based on feature divergence). Example contrastive explanations based on the present disclosure may be intuitive and well accepted by users, not only giving justification for decision making, but also providing direction for the next best action with respect to machine learning model maintenance.

In some embodiments, the bias detection and mitigation techniques of the present disclosure implement an individual fairness approach using a model trust score supplemented by feature divergence insights. For example, the bias detection and mitigation techniques may comprise a staged fairness assessment approach that incrementally assesses the fairness of a model through a series of collaborative input, feature extraction, and scoring stages. By way of example, the bias detection and mitigation technique may comprise a user input stage 402, a feature extraction, classification and similarity computation stage 404, a model trust score and explanation generation stage 406, and/or the like. In some embodiments, up to each of these stages may be implemented by a computing system, such as the computing system 101, to improve machine learning bias detection and mitigation.

In some embodiments, the computing system 101 receives a request from a user that comprises a target identifier 412 and/or identifies one or more target bias features 414. For example, the computing system 101 may receive the request from a client computing entity associated with a user during the user input stage 402 of the bias detection and mitigation technique. In some examples, the request may be received from an explainer user interface 436. For example, the client computing entity may render the explainer user interface 436 on a display, and the user may provide a user input to the client computing entity to trigger the client computing entity to generate and transmit the request to the computing system 101.

In some embodiments, the target identifier 412 is an identifier that uniquely identifies an entity associated with a trained machine learning model 408. In some embodiments, the trained machine learning model 408 is a machine learning model that has been trained to generate prediction outputs (for example, but not limited to, the prediction output 410) based on features and/or feature vectors (for example, but not limited to, the feature vector 418). In some embodiments, the trained machine learning model 408 may be any type of machine learning model such as, but not limited to, a supervised machine learning model, a generative pre-trained transformer, a generative adversarial network, and/or the like.

The target identifier 412, for example, may correspond to an input entity that serves as a basis for a prediction output 410 previously generated by the trained machine learning model 408. For example, the trained machine learning model 408 may generate a prediction output 410 based on an input entity associated with the target identifier 412. The entity may depend on the prediction domain. For example, the entity may comprise a user, such as a requesting user (and/or other user) who requests assessment of individual fairness in the prediction output 410 from the trained machine learning model 408. In addition, or alternatively, the entity may comprise an image (e.g., for an image classification model), a data entry (e.g., within a data record), a computer, and/or the like, depending on the prediction domain and/or classification task of the trained machine learning model 408. For example, with respect to an image, the trained machine learning model 408 may comprise an image classifier that is trained to generate an image classification (e.g., a prediction output 410) for one or more components of the image.

The target identifier 412 may comprise any uniquely identifying value for an entity, such as a member identification number, a username, an email address, and/or the like, in embodiments in which the entity corresponds to a user. In examples where the entity corresponds to an organization, the target identifier 412 may comprise any uniquely identifying value such as, but not limited to, organization name, organization identification number, and/or the like. As another example, the target identifier 412 may comprise an image identifier for an image, a hardware identifier for a computer, and/or the like.

In some embodiments, the target identifier 412 corresponds to a set of feature values that respectively describes one or more characteristics of a corresponding entity. As used herein, a “feature value” may refer to a value of a given feature if not specified otherwise. For example, a feature value may comprise one of one or more defined values of a feature evaluated by the trained machine learning model 408 (e.g., received via an input layer of the model) to generate the prediction output 410. In some examples, the target identifier 412 may correspond to a set of feature values that respectively correspond to the set of features evaluated by the trained machine learning model 408. In some examples, a feature and/or one or more feature values thereof may be specific to the trained machine learning model 408. For example, in a user classification model within a healthcare domain, the features may comprise one or more user attributes, such as a user's age, gender, employment status, location, diagnosis history, and/or any other data related to the health of a user. As another example, in a computer security domain, the set of features may comprise one or more software applications, access credentials, age, usage rates, and/or the like that may be related to a security and/or performance of a computer. In addition, or alternatively, in an image classification model, the features may comprise one or more image attributes, such pixel intensities, image size, contrast, color densities, boundaries, and/or the like. Thus, an entity, a set of features, and/or a prediction output 410 of the trained machine learning model 408 may comprise any variation of data depending on prediction domain.

In some examples, the set of features may comprise one or more target bias features 414 that may be pre-identified or identified by a request. A target bias feature 414, for example, may comprise a type of feature that is identified for bias analysis by the request. The target bias feature 414 may comprise any feature from the set of features that is designated as a target by the request.

In some embodiments, in response to the request, the computing system 101 receives a first set of feature values for a set of features and corresponding to the target identifier 412. In some examples, the set of feature values may be encoded as a feature vector. For example, the computing system 101 may receive a feature vector 418 associated with the target identifier 412 from a feature store 416 that stores training data for the trained machine learning model 408. For example, the computing system 101 may receive a feature vector previously used by the trained machine learning model 408 to generate the prediction output 410. By way of example, during inference, the trained machine learning model 408 may receive a set of feature values for the entity. The trained machine learning model 408 may convert (e.g., via an embedding layer) the feature values to a feature embedding for subsequent processing via one or more encoding layers of the model. The trained machine learning model 408 may generate one or more intermediate feature representations (e.g., via one or more encoding layers, attention layers) based on the feature embedding and output the prediction output 410 from the intermediate feature representations. In some examples, at any stage of an inference process, the computing system 101 may receive an intermediate representation (e.g., feature embedding, intermediate feature representation) and store the intermediate representation as a feature vector 418 in associated with the target identifier 412 and/or the prediction output 410.

In addition, or alternatively, the computing system 101 may encode, using an encoder, the set of feature values as the feature vector 418. The feature vector 418, for example, may comprise a structured representation of data associated with an entity. In some examples, the feature vector 418 may comprise an encoded representation of a set of feature values from the feature store 416 that correspond to an entity. The feature values, for example, may comprise entity-specific values for up to each feature of a set of features on which the trained machine learning model 408 is trained. By way of example, the set of features may comprise a set of learned features that is weighted, via one or more training operations of the trained machine learning model 408, to generate the prediction output 410. The set of feature values for an entity may comprise a feature value for up to each of the set of features. In some examples, the feature vector 418 may be generated by arranging the set of feature values in a feature value sequence and encoding, using a natural language processing and/or machine learned encoder (e.g., word2vec, Global Vectors (GloVe), bidirectional encoder representations from transformers (BERT)), the feature value sequence into a continuous vector space.

In some embodiments, the feature store 416 comprises a data repository that stores training and/or evaluation data associated with the trained machine learning model 408. In some examples, the feature store 416 may store a training dataset comprising a set of training entries used for machine learning model training. Up to each training entry of the set of training entries, for example, may comprise a set of training feature values and a corresponding ground truth label. In addition, or alternatively, the feature store 416 may store an inference dataset that comprises a set of inference entries. Up to each inference entry of the set of inference entries may comprise one or more of a set of feature values, such as the set of feature values corresponding to target identifier 412, a feature vector, such as the feature vector 418, and/or the prediction output 410. In this manner, the feature store 416 (e.g., via a training and/or inference dataset) may comprise a plurality of feature sets respectively corresponding to a plurality of different entities associated with different predictive characteristics.

In some embodiments, the computing system 101 generates one or more feature classifications 420 for the set of features corresponding to the target identifier 412 based on the one or more target bias features 414 of the request. For example, the computing system 101 may process the set of features using one more machine learning classifiers to tag up to each of the set of features as a target bias feature (e.g., as defined by the request), a target proxy feature, and/or a target domain-related feature. The target proxy feature, for example, may comprise a feature of the set of features that is a proxy and/or predictor of a target bias feature (e.g., a location being indirectly predictive of a marital status). In some embodiments, the target domain-related feature is a feature of the set of features that is not a target bias feature and/or a target proxy feature.

In some embodiments, the feature vector associated with the target identifier 412 may comprise the target proxy feature and the target domain-related feature that are generated using a machine learning classifier. In some embodiments, the machine learning classifier comprises a machine learning model, such as logistic regression models, Random Forest models, neural networks, and/or the like. For example, the machine learning classifier may comprise a supervised machine learning model, an unsupervised machine learning model, a reinforcement learning model, a semi-supervised model, and/or the like. In some examples, the computing system 101 may train the machine learning classifier to predict the value of a target bias feature based on other features within a feature set. The machine learning classifier, for example, may be trained using the training and/or inference datasets for the feature store 416. Subsequent to training the machine learning classifier, the computing system 101 may apply a feature explanation technique to determine an influence of up to each of the set of features on a target bias feature value prediction. By way of example, a feature influence on the target bias feature value prediction may be measured as SHapley Additive explanations (SHAP) value. In some examples, the computing system 101 may compare the influence values (SHAP and/or any other measure of feature influence) of up to each of the set of features to one or more thresholds to generate the one or more feature classifications 420 for the set of features. For instance, a first feature classification (e.g., target proxy feature classification) may be generated for an influence value that meets or exceeds an influence threshold (e.g., .2 .5, .6), and a second feature classification may be generated for an influence value that does not meet the influence threshold.

In some examples, the machine learning classifier may be specific to one target bias feature. For example, a separate machine learning classifier may be trained for up to each of the one or more target bias features of the request.

In addition, or alternatively, the machine learning classifier may comprise a correlation analysis model that detects proxy features based on a relative distribution of features within the training and/or inference datasets of the feature store 416. For example, the correlation analysis model may identify correlations between variables in two subsets (one representing target bias feature and the other representing other features in the same feature set). In some examples, the correlation analysis model may identify a positive correlation between two variables, where an increase in one variable leads to an increase in the other variable. In some examples, the correlation analysis model may identify a negative correlation between two variables, where an increase in one variable leads to a decrease in the other variable. In some examples, the correlation analysis model may identify no correlation between two variables.

In some examples, the correlation analysis model may determine a correlation coefficient that indicates a strength of linear relationship between the two variables. In some examples, the correlation coefficient may be a value between-1 and 1. For example, the correlation analysis model may determine that the correlation coefficient is-1, which indicates a perfect negative correlation. As another example, the correlation analysis model may determine that the correlation coefficient is 0, which indicates no correlation. As another example, the correlation analysis model may determine that the correlation coefficient is 1, which indicates a perfect positive correlation.

In some examples, the correlation coefficient may be a Pearson correlation coefficient. In some examples, the computing system 101 may determine the Pearson correlation coefficient based on the following formula:

$$r = \frac{\sum ( {x}_{i} - \overline{x} ) ( {y}_{i} - \overline{y} )}{\sqrt{\sum {( {x}_{i} - \overline{x} )}^{2} \sum {( {y}_{i} - \overline{y} )}^{2}}}$$

In the above formula, r is Pearson correlation coefficient, xᵢ is the feature value of a target bias feature, x is the average feature value of the target bias features, yᵢ is the feature value of other feature, and y is the average feature value of other features.

In some examples, the computing system 101 may compare the correlation coefficient with a predetermined threshold (e.g., .5, .7). If the computing system 101 determines that the correlation coefficient between the target bias feature and another feature satisfies (e.g., meets or exceeds) the predetermined threshold, the computing system 101 determines that the other feature is a proxy feature of the target bias feature. If the computing system 101 determines that the correlation coefficient between the target bias feature and another feature does not satisfy (e.g., meets or exceeds) the predetermined threshold, the computing system 101 determines that the other feature is a proxy feature of the target bias feature.

In some embodiments, the computing system 101 determines a comparison feature vector for the target identifier. For example, the computing system 101 may determine one or more comparison identifiers 422 from the feature store 416 based on the feature vector 418. A comparison identifier 422, for example, may comprise an identifier for another entity that is previously processed by the trained machine learning model 408. By way of example, the comparison entity may receive a comparison prediction output from the trained machine learning model 408 based on a comparison feature vector reflective of a set of feature values specific to the comparison entity. In some examples, up to each of the one or more comparison identifiers 422 may correspond to one or more of a set of features, a feature vector (e.g., comparison feature vector), and/or the prediction output 410 of a training and/or inference entry within the feature store 416.

In some embodiments, the computing system 101 determines a comparison identifier 422 for the target identifier 412 during the feature extraction, classification and similarity computation stage 404. To do so, the computing system 101 may compare the feature vector 418 to a set of feature vectors from the feature store 416 to extract the one or more comparison identifiers 422 for the target identifier 412.

In some examples, the computing system 101 may perform similarity comparison to determine the comparison identifier 422 for the target identifier 412. For example, the computing system 101 may determine the comparison identifier 422 based on an embedding comparison between the feature vector 418 that is associated with the target identifier 412 and a comparison feature vector that is associated with the comparison identifier 422.

In some embodiments, the embedding comparison is a process of analyzing and evaluating similarity, dissimilarity, and/or relationship between two or more embeddings (for example, features in two different feature vectors). In some embodiments, the computing system 101 may perform embedding comparison based on a near neighbor algorithm to determine the comparison identifier 422 and/or the comparison feature vector associated with the comparison identifier 422.

In some embodiments, the computing system 101 may determine the comparison feature vector based at least in part on a distance between a first embedding generated for the feature vector 418 that is associated with the target identifier 412 and a second embedding generated for the comparison feature vector. For example, the near neighbor algorithm may identify the nearest neighbor to the feature vector 418 associated with the target identifier 412 in vector space based on determining pairwise distances (e.g., Euclidian distance, cosine similarity) between the first embedding generated for the feature vector 418 that is associated with the target identifier 412 and embeddings generated for other feature vectors in the vector space. In some examples, the computing system 101 may sort and/or filter the pairwise distances to identify a number k of other feature vectors (associated with k comparison entities) in the feature space that have the shortest distance to the feature vector 418 associated with the target identifier 412. In some examples, the computing system 101 segregates the number k of other feature vectors based on their corresponding prediction outputs.

In some embodiments, the computing system 101 compares the prediction output 410 associated with the feature vector 418 and up to each comparison prediction output associated with up to each of the number k of other feature vectors. In some embodiments, the computing system 101 determines one or more feature vectors from the number k of other feature vectors that are associated with prediction outputs different from the prediction output 410, and determine the comparison feature vector as the feature vector having the shortest distance to the feature vector 418 among the one or more feature vectors. As such, the computing system 101 determines the comparison feature vector as the feature vector that is similar to the feature vector 418 associated with the target identifier 412 but results in a different prediction output from the trained machine learning model 408.

In some examples, the computing system 101 may determine a model coherence score (MCS) 418, during the model trust score and explanation generation stage 406, based on the number of instances where the prediction output 410 and up to each of comparison prediction outputs (associated with up to each of the number k of other feature vectors) are different.

In some embodiments, the model coherence score (MCS) is a value that indicates whether prediction outputs from the trained machine learning model are consistent among similar entities (e.g., the k comparison entities). For example, the model coherence score 424 may comprise a value from zero to one. For instance, the model coherence score 424 may comprise a purity metric (e.g., entropy) based on the following equation:

$$MCS = \frac{count of class ( A )}{k}$$

where count of class (A) is the number of comparison entities among the k comparison entities that all receive a particular type of prediction output 410 (e.g., rejecting care recommendations in a healthcare domain) and k is a total number of comparison entities associated with a target identifier 412.

In this manner, the MCS may identify a degree of disagreement between the prediction output 410 associated with the target identifier 412 and a comparison prediction output associated with the comparison identifier 422.

For example, when the MCS equals one, there may be complete agreement (e.g., no difference) between the prediction output 410 associated with the target identifier 412 and the comparison prediction output associated with the comparison identifier 422. In such an example, the MCS indicates that the trained machine learning model 408 generates similar prediction outputs based on similar feature vectors.

When the MCS is less than one, there may be at least partial disagreement (e.g., one or more differences) between the prediction output 410 associated with the target identifier 412 and the comparison prediction output associated with the comparison identifier 422. In such an example, the MCS indicates that the trained machine learning model 408 generates different prediction outputs based on similar feature vectors.

In some embodiments, the computing system 101 proceeds to a model trust scoring and explanation generation stage 406 that comprises a model trust scoring stage and an explanation generation stage. At the explanation stage, for example, the computing system 101 may generate a feature divergence ranking 430 as an additional input to the model trust scoring stage to supplement an MCS that fails to satisfy an initial score threshold (for example, the MCS being less than 1). Otherwise, the computing system 101 may proceed directly to the model trust scoring stage. For example, in response to a determination that the MCS satisfies the initial score threshold (for example, the MCS equating 1), the computing system 101 may proceed to the model trust scoring stage.

In some embodiments, the computing system 101 may determine a subset of influential features 426 (in some cases referred to as a “first subset of features” or “subset of features” or similar phrase) from the set of features based on contribution scores relating the set of feature values to the prediction output 410.

For example, the computing system 101 may determine a first contribution score for a first feature in the feature vector 418 associated with the target identifier 412. In some embodiments, the contribution score is a quantitative measure that evaluates the impact and/or amount or degree of influence of a feature value on a machine learning model output. For example, the first contribution score may indicate an importance associated with the first feature in the feature vector 418 with regards to the prediction output 410. In some embodiments, the higher the contribution score, the more influence that a feature has on the predicted outcome. In some embodiments, a contribution score may be in the form of a Shapley value. In some embodiments, the contribution score indicates an extent to which a prediction of a machine learning model is based on a specified feature. In some embodiments, the first contribution score is one of a set of contribution scores for the first set of features that the computing system 101 generates.

In some examples, the computing system 101 may determine a contribution score associated with a feature in the set of features by utilizing a feature explanation technique. For example, the computing system 101 may change the value associated with the feature in the set of features, input the set of features to the trained machine learning model 408, and determine an amount of change to the prediction output 410 of the trained machine learning model 408. In some examples, the contribution score is based at least in part on an amount of change in outputs of the trained machine learning model 408 when inputs to the trained machine learning model 408 are changed from a first feature value of a first feature vector to a second feature value of the comparison feature vector. In such examples, the first feature value and the second feature value each corresponds to the first feature of the first set of features. If the amount of change to the prediction output 410 is low, the computing system 101 may determine a low contribution score for the feature. If there is substantial change to the prediction output 410, the computing system 101 may determine a high contribution score for the feature.

In some examples, the contribution scores may be predetermined during the machine learning model training. In some examples, the computing system 101 may compare the contribution score to a contribution score threshold. If the contribution score satisfies the contribution score threshold, the computing system 101 may determine that the feature is an influential feature. If the contribution score does not satisfy the contribution score threshold, the computing system 101 may determine that the feature is not the influential feature. As used herein, if a value is said to “satisfy” a threshold, the value may exceed the threshold, be less than the threshold, be greater than or equal to the threshold, or less than or equal to the threshold, depending on the nature of the threshold as a criterion.

Additional details associated with contribution scores in some examples are discussed in U.S. patent application Ser. No. 18/986,865, filed on Dec. 19, 2024 and titled “MACHINE LEARNING EXPLAINABILITY FRAMEWORK FOR MACHINE LEARNING CLASSIFIERS BASED ON LABELED BINARY VECTORS FOR A DATA,” the entirety of which is incorporated by reference herein.

In some embodiments, the computing system 101 determines a set of divergent features comprising one or more features from the subset of features based on feature divergence 428. For example, the computing system 101 may determine a feature divergence based on feature values of influential features 426 in the feature vector 418 associated with the target identifier 412 and feature values of influential features 426 in the comparison feature vector associated with the comparison identifier 422. For example, the computing system 101 may determine the absolute feature difference, Kullback-Leibler divergence, and/or other statistical distance between influential features 426 in the feature vector 418 and in the comparison feature vector. In some examples, determining set of divergent features comprises determining to include a first feature from the subset of influential features 426 as a first divergent feature in the set of divergent features when a difference (e.g., absolute feature difference, Kullback-Leibler divergence, and/or other statistical distance) between the first divergent feature and a second feature of the comparison feature vector satisfies a difference threshold.

In some embodiments, the computing system 101 generates a feature divergence ranking 430 based on one or more influential features 426 to a prediction output 410. In some embodiments, the feature divergence ranking is a ranking of features based on their degree of divergence in the feature vector 418 and in the comparison feature vector. In some embodiments, a feature divergence ranking indicates how much a feature's value differs between the feature vector 418 and the comparison feature vector. In some embodiments, the computing system 101 generates a feature divergence ranking based on the average feature divergence associated with the influential features 426 in the feature vector 418 and in the comparison feature vector.

In some embodiments, the computing system 101 determines the model trust score 432 based on the MCS and/or the feature divergence ranking. In some embodiments, the model trust score is a score or a categorical label that indicates model trustworthiness associated with the trained machine learning model 408. In some examples, in response to a determination that the MCS satisfies the initial score threshold, the computing system 101 may generate a model trust score 432 that indicates the trained machine learning model 408 is trustworthy and there is no bias. In addition, or alternatively, the computing system 101 may generate the model trust score 432 based on a type of influential features 426 that ranks high in the feature divergence ranking. In some embodiments, a trust score may comprise a categorical label such as “low,” “medium,” or “high” according to rules that are based at least in part on a type of feature contributing to model output. In some embodiments, the model trust score 432 (also referred to as bias indicator) is based at least in part on relative ranking positions of the target bias feature, the target proxy feature, and the target domain-related feature. For example, if a type of feature contributing to model output is identified as a sensitive (or similar designation), then the model trust score 432 may be “low” whereas if the type of contributing features contributing to the model output is identified as proxy (or similar designation) then the model trust score 432 may be “medium” or “high.” In some embodiments, a machine learning model may learn from training examples of rules such as those described above and subsequently predict a categorical trust score for a new instance. In some embodiments, the model trust score may comprise a numerical value. For example, a numerical model trust score may be computed by (1) receiving a feature importance and feature weight list comprising values from 0 to 1, (2) determining a weighted sum of feature importance scores (for example: TS=(F1W1)+(F2W2)+(F3W3)+(F4W4)+(F5*W5), where TS is the trust score, F1, F2, F3, F4, and F5 are feature importance scores, and W1, W2, W3, W4, and W5 are weights) and (3) determining a deviation of the weighted sum from an expected sum. For example, an expected sum may be determined with all features weighted equally.

For example, if the influential features 426 that ranks high in the feature divergence ranking corresponds to a target bias feature (for example, but not limited to, location, gender, and/or the like), the computing system 101 may generate the model trust score indicating a low level (e.g. the trained machine learning model 408 is not trustworthy). In some embodiments, the computing system 101 may initiate retraining the trained machine learning model 408 to remove bias.

Additionally, or alternatively, if the influential features 426 that ranks high in the feature divergence ranking corresponds to a target proxy feature (for example, but not limited to, zip code, and/or the like), the computing system 101 may generate the model trust score indicating a medium level (e.g. the trained machine learning model 408 is somewhat trustworthy). In some embodiments, the computing system 101 may exclude such target proxy features during the training process of the trained machine learning model 408.

Additionally, or alternatively, if the influential features 426 that rank high in the feature divergence ranking correspond to a target domain-related feature, the computing system 101 may generate the model trust score indicating a high level (e.g. the trained machine learning model 408 is trustworthy).

In some embodiments, during the model trust score and explanation generation stage 406, the computing system 101 may provide a response based on the model trust score (which may also be referred to as a “bias indicator” or similar terminology) through an explainer module 434.

In some embodiments, the bias indicator comprises the model trust score. For example, if the bias indicator indicates a high level, the computing system 101 may determine that there is no bias with regards to the predicted output associated with the target identifier 412. In some embodiments, the computing system 101 may generate an explainer user interface 436 that provides an aggregated view of features associated with comparison feature vectors.

Additionally, or alternatively, if the bias indicator satisfies a threshold level, the computing system 101 may generate one or more bias mitigation recommendations 438 (such as, but not limited to, debiasing a feature, retraining the machine learning model, and/or the like).

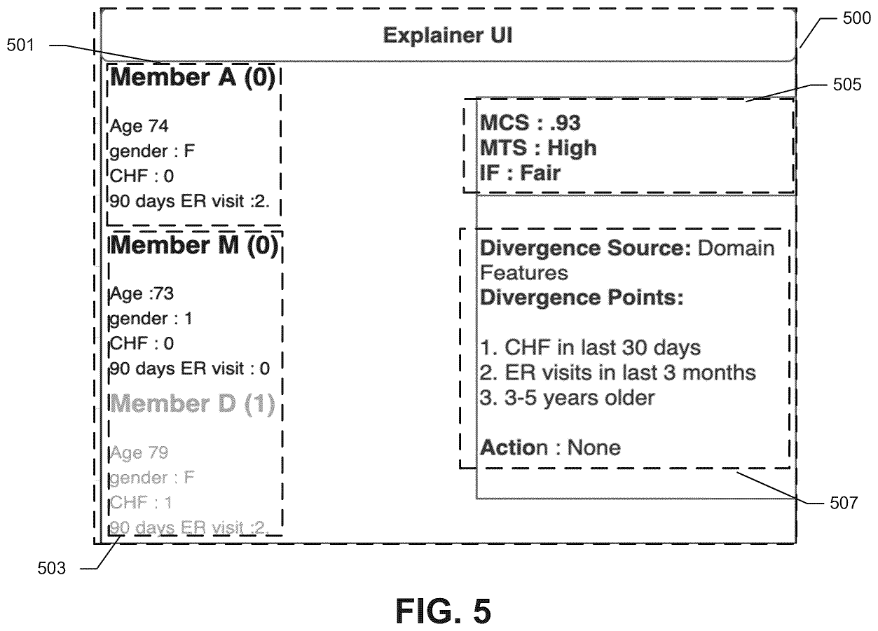

FIG. 5 is an operational example 500 of an example explainer user interface in accordance with some embodiments of the present disclosure. As shown in the operational example 500, the example explainer user interface provides not only an indication of individual fairness associated with a prediction output, but also features that may be relevant in causing the trained machine learning model to generate such prediction outputs, enabling users to identify specific factors and/or conditions that influenced the model's decisions.

In the example shown in FIG. 5, the example explainer user interface comprises an aggregated target feature portion 501 and an aggregated comparison feature portion 503. In some embodiments, the aggregated target feature portion 501 displays target features associated with the target entity (for example, age, gender, a number of congestive heart failures, a number of ER visits, and/or the like). In some embodiments, the aggregated comparison feature portion 503 displays comparison features associated with the comparison entity (for example, age, gender, a number of congestive heart failures, a number of ER visits, and/or the like).

In some embodiments, the example explainer user interface comprises a bias indicator portion 505. In some embodiments, the bias indicator portion 505 displays information such as, but not limited to, the model coherence score, the model trust score, the individual fairness level, and/or the like.

In some embodiments, the example explainer user interface comprises a divergence information portion 507. In some embodiments, the divergence information portion 507 may display information, such as, but not limited to, source of divergence (e.g., whether the influential features are target bias feature, target proxy feature, or target domain-related feature). In some embodiments, the divergence information portion 507 may display feature values associated with the influential features (for example, a number of congestive heart failure, a number of ER visits, and/or the like).

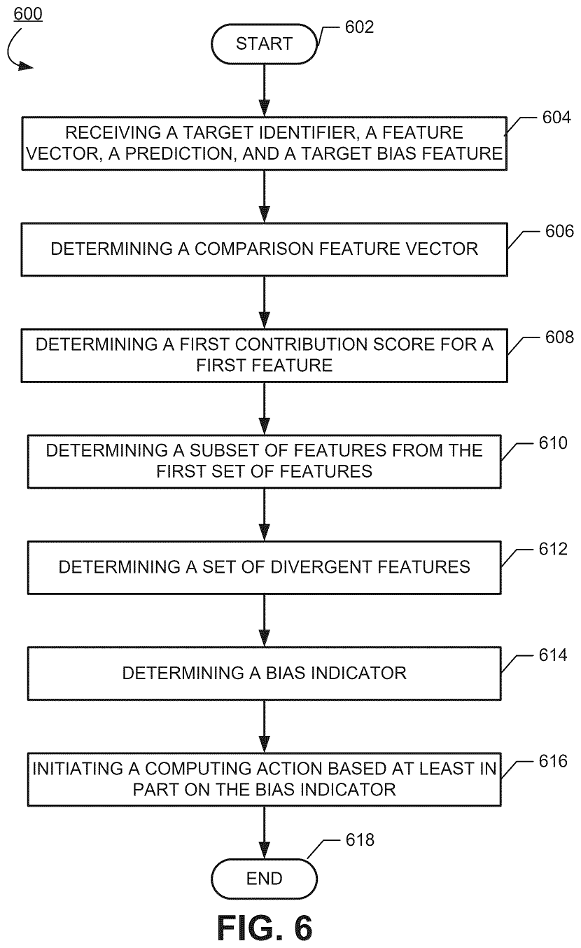

FIG. 6 is a flowchart diagram of an example machine learning bias detection process 600 in accordance with some embodiments of the present disclosure. The flowchart diagram depicts detecting bias in prediction output from a machine learning model. The process 600 may be implemented by one or more computing devices, entities, and/or systems described herein. For example, via the various steps/operations of the process 600, the computing system 101 may reduce the complexity of bias detection through feature divergence. By doing so, the process 600 improves computer functionality by improving the speed of bias detection without reducing the granularity and feature-level explainability of individual fairness approaches.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the example process 600 starts at operation 602.

In some embodiments, the process 600 comprises, at operation 604, receiving (i) a target identifier, (ii) a feature vector associated with the target identifier and indicating a first set of feature values for a set of features, (iii) a prediction previously generated by a machine learning model using the feature vector, and (iv) a target bias feature associated with the feature vector. For example, the computing system 101 may receive the request from a client computing entity (e.g., the client computing entity 102 described above in connection with FIG. 1).

In some embodiments, the target identifier is associated with a target entity. In some embodiments, the target identifier corresponds to a prediction output previously generated by a trained machine learning model using the feature vector. For example, the target entity may request an assessment of individual fairness in the prediction output.

In some embodiments, the target bias feature 414 is associated with the feature vector 418. As described above, a target bias feature refers to a type of feature in a feature vector that may be prone to causing bias in prediction output from trained machine learning models (such as, but not limited to, location, gender, and/or the like) or may be sensitive for reasons including laws and regulations governing bias in particular features.

In some embodiments, the process 600 comprises, at operation 606, determining a comparison feature vector for the target identifier based at least in part on a distance between a first embedding generated for the feature vector and a second embedding generated for the comparison feature vector.

In some embodiments, the comparison feature vector is associated with the comparison identifier 422. In some embodiments, the comparison identifier 422 is associated with the comparison entity. In some embodiments, the computing system 101 determines a comparison identifier 422 (in some cases simply called a “comparison”) for the target identifier. In some embodiments, the computing system 101 determines the comparison feature vector based on an embedding comparison between a first embedding generated for the feature vector (that is associated with the target identifier) and a second embedding generated for the comparison feature vector. For example, the computing system 101 may determine a pairwise distance value based on the feature vector and the comparison feature vector to determine the nearest neighbor to the feature vector in the vector space, and determine such nearest neighbor as the comparison feature vector.

In some embodiments, the computing system 101 may determine whether a prediction output associated with the target entity is different from the comparison prediction output associated with the comparison entity. In some embodiments, the prediction output may be in the form of a binary value (1 or 0). In such examples, the computing system 101 may determine that there is a mismatch if the binary value of prediction output associated with the target entity is 0 while the comparison prediction output associated with the comparison entity is 1. In some embodiments, the computing system 101 may determine whether a prediction output associated with the target entity differs from the comparison prediction output associated with the comparison entity by more than a threshold amount. In some embodiments, the prediction output may be in the form of a value from 0 to 1. In such examples, the computing system 101 may determine that there is a mismatch if the value of prediction output associated with the target entity is 0.3 while the comparison prediction output associated with the comparison entity is 0.7 and the threshold for determining a mismatch is 0.2 (since 0.7-0.3>0.2). If there is no mismatch between the prediction output and the comparison prediction output, the computing system 101 may determine that the target entity receives the same prediction output as those of similar users, and may determine that the trained machine learning model is trustworthy (e.g., a high model trust score). If there is a mismatch between the prediction output and the comparison prediction output, the computing system 101 may determine that the target entity receives different prediction output as those of similar users.

In some embodiments, the process 600 comprises, at operation 608, determining a first contribution score for a first feature. In some embodiments, the first feature is from the first set of features associated with the feature vector.

In some embodiments, the first contribution score is based at least in part on an amount of change in outputs of the machine learning model when inputs to the machine learning model are changed from a first value of a first feature vector to a second value of the comparison feature vector. In some embodiments, the first value and the second value each corresponds to the first feature of the first set of features. In some embodiments, the first contribution score indicates an extent to which the prediction is based on the first feature.

In some embodiments, the first contribution score is one of a set of contribution scores for the first set of features. For example, the computing system 101 generates the set of contribution scores by generating a contribution score for each feature in the first set of features.

In some embodiments, the process 600 comprises, at operation 610, determining a subset of influential features (in some cases referred to as a “first subset of features” or “subset of features” or similar phrase) from the set of features associated with the feature vector.

In some embodiments, the computing system 101 determines the subset of features from the first set of features based at least in part on the set of contribution scores. As described above, a contribution score indicates a measure that evaluates the impact of a feature value on the prediction output. In some embodiments, the computing system 101 may compare the contribution scores with a contribution score threshold, and select the subset of features that are associated with contribution score(s) satisfying the contribution score threshold. In some embodiments, the computing system 101 may rank the set of features based on their corresponding contribution scores, and may determine the subset of features by selecting the top features according to their contribution scores.

In some embodiments, the process 600 comprises, at operation 612, determining a set of divergent features. In some embodiments, the set of divergent features comprises one or more features of the subset of features described above in connection with operation 610.

In some embodiments, the computing system 101 may determine to include a first divergent feature in the set of divergent features based at least in part on a difference between the first divergent feature and a second feature satisfying a threshold difference. For example, the computing system 101 may compare a feature value from the feature vector that corresponds to an influential feature with a feature value from the comparison feature vector that corresponds to the influential feature. In some embodiments, the higher the difference between the feature values of the influential feature, the higher divergence that influential feature has in a feature divergence ranking. In some embodiments, the computing system 101 determines to include the influential feature as a first divergent feature in the set of divergent features if the difference satisfy the threshold difference.

In some embodiments, the process 600 comprises, at operation 614, determining a bias indicator. In some embodiments, a bias indicator indicates an extent to which the set of divergent features cause the prediction to differ from one or more predictions associated with different target identifiers. In some embodiments, the computing system 101 determines the bias indicator based on the set of divergent features, the difference and the target bias feature. For example, the computing system 101 may determine whether the set of divergent features comprises a target bias feature. If so, the computing system 101 may determine the bias indicator having a low trustworthy level.

In some embodiments, the process 600 comprises, at operation 616, initiates a computing action based at least in part on the bias indicator. The computing action may include, for example, providing a response to the request that identified the bias indicator. In some embodiments, the response to the request may indicate a trustworthy level associated with the trained machine learning model in generating the prediction output. For example, the response may comprise a model trust score that is rendered on an explainer user interface, such as, but not limited to, the explainer user interface illustrated and described above in connection with FIG. 5. In such examples, the process 600 may comprise generating, by a generative model and based at least in part on the set of divergent features, a statement indicating at least one of a reason for or an extent of bias in the prediction and at least one of storing or causing display, via a user interface, the statement in association with the prediction.

In some embodiments, the computing action may include, for example, retraining or decoupling the machine learning model to remove bias. For example, the computing system 101 may disable or retrain the machine learning model based at least in part on determining that the bias indicator satisfies a first criterion (for example, the bias indicator indicates high bias or if the bias indicator indicates a bias score being higher than a threshold).

In some embodiments, the computing action may modify an output of the machine learning model to remove bias.

Some techniques of the present disclosure enable the generation of action outputs that may be performed to initiate one or more real world actions to achieve real-world effects. The techniques of the present disclosure may be used, applied, and/or otherwise used to improve the individual fairness of predicted output from trained machine learning models. In some examples, the bias indicator of the present disclosure may trigger action outputs (e.g., through control instructions) to automate machine learning model retraining and/or the like. The action outputs may control various aspects of a client device, such as the display, transmission, and/or the like of data reflective of an alert, and/or the like. The alert may be automatically communicated to a user and/or may be used to initiate a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like. In some embodiments, the computing action may include sending data reflective of an alert, automated notification, automated scheduling operation, automated precautionary action, automated security action, or automated data processing action.

In some embodiments, subsequent to operation 616, the example process 600 proceeds to operation 618 and ends.

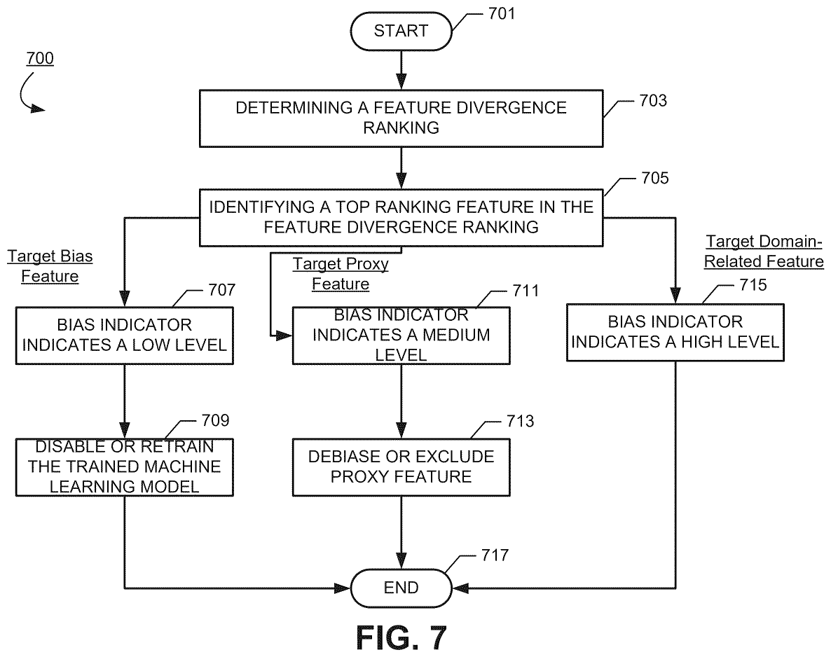

FIG. 7 depicts a flowchart diagram of an example machine learning bias detection process 700 in accordance with some embodiments of the present disclosure. The flowchart diagram depicts mitigating machine learning bias based on the bias indicator. The process 700 may be implemented by one or more computing devices, entities, and/or systems described herein. For example, via the various steps/operations of the process 700, the computing system 101 may automate machine learning model retraining based on the bias indicator. By doing so, the process 700 improves computer functionality by improving the accessibility to and frequency of bias detection and mitigation scheme, which may improve machine learning reliability in various use cases.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

The example process 700 starts at operation 701. In some embodiments, subsequent to operation 701, the example process 700 proceeds to operation 703. In some embodiments, the process 700 comprises, at operation 703, determining a set of divergent features.

For example, the computing system 101 may determine the set of divergent features based on a comparison between (i) a first subset of feature values corresponding to the subset of influential features and from the feature vector and (ii) a second subset of feature values corresponding to the subset of influential features and from the comparison feature vector, similar to various examples described above in connection with at least FIG. 4 and FIG. 6.

In some embodiments, the process 700 comprises, at operation 705, identifying a feature in the set of divergent features. As described above in connection with at least FIG. 4, a set of divergent features include features that differ more than a threshold amount between the feature vector associated with the target identifier and the comparison feature vector associated with the comparison identifier. In some embodiments, the feature refers to a feature that differs the most across the feature vector and the comparison feature vector.

If, at operation 705, the process 700 determines that the feature in the set of divergent features is a target bias feature, the process 700 proceeds to operation 707. In some embodiments, at operation 707, the process 700 comprises indicating a low level for the bias indicator.

For example, if the top ranking feature is a target bias feature, the computing system 101 determines that the different prediction outputs between the target entity and the comparison entity may be caused by the target bias feature. In such an example, the computing system 101 determines that there is bias in generating the prediction output for the target entity by the trained machine learning model.

In some embodiments, at operation 709, the process 700 comprises disabling or retraining the trained machine learning model. For example, the computing system 101 may remove or mask the target bias feature when training the machine learning model. In such an example, the machine learning model does not analyze the target bias feature when generating prediction output, thereby reducing bias caused by the target bias feature.

In some embodiments, subsequent to operation 709, the process 700 proceeds to operation 717 and ends.

If, at operation 705, the process 700 determines that the top ranking feature in the feature divergence ranking is a target proxy feature, the process 700 proceeds to operation 711. In some embodiments, at operation 711, the process 700 comprises indicating a medium level for the bias indicator.

For example, if the top ranking feature is a target bias feature, the computing system 101 determines that the different prediction outputs between the target entity and the comparison entity may be caused by the target proxy feature. Because the target proxy feature is a predictor of a target bias feature, the computing system 101 may determine that there may be some bias in generating the prediction output for the target entity by the trained machine learning model.

In some embodiments, subsequent to operation 711, the process 700 proceeds to operation 713. In some embodiments, at operation 713, the process 700 comprises debiasing or excluding proxy features.

For example, the computing system 101 may determine a contribution score that indicates a contribution level of the proxy feature to the prediction output. Based on the contribution level, the computing system 101 may replace feature values associated with the proxy feature with a randomized value so as to debias the proxy features.

In some embodiments, subsequent to operation 713, the process 700 proceeds to operation 717 and ends.

If, at operation 705, the process 700 determines that the top ranking feature in the feature divergence ranking is a target domain-related feature, the process 700 proceeds to operation 715. In some embodiments, at operation 715, the process 700 comprises indicating a high level for the bias indicator.

For example, if the top ranking feature is a target domain-related feature, the computing system 101 determines that the different prediction outputs between the target entity and the comparison entity may be caused by the target domain-related feature. Because the target domain-related feature is not a target bias feature and is not a predictor of a target bias feature, the computing system 101 may determine that there is no bias in generating the prediction output for the target entity by the trained machine learning model.

Some techniques of the present disclosure enable the generation of action outputs that may be performed to initiate one or more real world actions to achieve real-world effects. The techniques of the present disclosure may be used, applied, and/or otherwise used to improve the individual fairness of predicted output from trained machine learning models. In some examples, the bias indicator of the present disclosure may trigger action outputs (e.g., through control instructions) to automate machine learning model training and/or the like. The action outputs may control various aspects of a client device, such as the display, transmission, and/or the like of data reflective of an alert, and/or the like. The alert may be automatically communicated to a user and/or may be used to initiate a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

In some embodiments, subsequent to operation 715, the process 700 proceeds to operation 717 and ends.

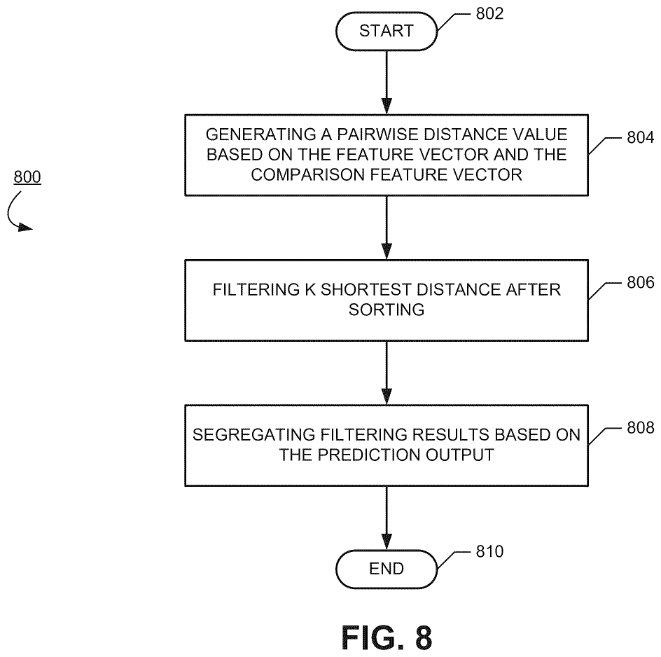

FIG. 8 depicts a flowchart diagram of an example comparison identifier determination process 800 in accordance with some embodiments of the present disclosure. The flowchart diagram depicts determining a comparison identifier for generating a bias indicator. The process 800 may be implemented by one or more computing devices, entities, and/or systems described herein. For example, via the various steps/operations of the process 800, the computing system 101 may explain model decisions among similar data objects (e.g., nearest neighbors). By doing so, the process 800 improves computer functionality by improving the speed of bias detection without reducing the granularity and feature-level explainability of individual fairness approaches.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

The example process 800 starts at operation 802. In some embodiments, subsequent to operation 802, the example process 800 proceeds to operation 804. In some embodiments, the process 800 comprises, at operation 804, generating a pairwise distance value based on the feature vector and the comparison feature vector.

In some embodiments, the pairwise distance value is a quantitative measure that presents the distance or dissimilarity between two features in the vector space. Alternatively, in some embodiments, the smaller the pairwise distance value, the higher values may indicate greater similarity between the comparison feature vector is to the feature vector.

In some embodiments, the process 800 comprises, at operation 806, filtering K shortest distance after sorting. In some embodiments, the computing system 101 determines pairwise distance values between the feature vector and comparison feature vectors in the vector space, and may sort the comparison feature vectors based on corresponding pairwise distance values. In some embodiments, the computing system 101 may filter the comparison feature vectors to identify those that are associated with the shortest distances to the feature vector. For example, the computing system 101 may select a number K of comparison feature vectors that have the smallest pairwise distance values to the feature vector. In such an example, such comparison feature vectors are the nearest neighbors to the feature vector in the vector space (e.g., the target entity is most similar to those comparison entities corresponding to the comparison feature vectors).

In some embodiments, the process 800 comprises, at operation 808, segregating filtering results based on the prediction output. In some embodiments, the computing system 101 may select a comparison feature vector from the comparison feature vectors sorted above in connection with operation 806 based on comparing the prediction output associated with the target identifier and the comparison prediction output associated with the comparison feature vectors. In some embodiments, the computing system 101 may determine a comparison identifier associated with a comparison feature vector filter at operation 806 that is associated with a comparison prediction output different from the prediction output associated with the feature vector.

Some techniques of the present disclosure enable the generation of action outputs that may be performed to initiate one or more real world actions to achieve real-world effects. The techniques of the present disclosure may be used, applied, and/or otherwise used to improve the individual fairness of predicted output from trained machine learning models. In some examples, the bias indicator of the present disclosure may trigger action outputs (e.g., through control instructions) to automate machine learning model retraining and/or the like. The action outputs may control various aspects of a client device, such as the display, transmission, and/or the like of data reflective of an alert, and/or the like. The alert may be automatically communicated to a user and/or may be used to initiate a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

In some embodiments, subsequent to operation 808, the process 800 proceeds to operation 810 and ends.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model comprising one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.
Example 1. A computer-implemented method comprising: receiving, by one or more processors, (i) a target identifier, (ii) a feature vector associated with the target identifier and indicating a first set of feature values for a set of features, (iii) a prediction previously generated by a machine learning model using the feature vector, and (iv) a target bias feature associated with the feature vector; determining, by the one or more processors, a comparison feature vector for the target identifier based at least in part on a distance between a first embedding generated for the feature vector and a second embedding generated for the comparison feature vector; determining, by the one or more processors, a first contribution score for a first feature, wherein the first contribution score: is based at least in part on an amount of change in outputs of the machine learning model when inputs to the machine learning model are changed from a first feature value of a first feature vector to a second feature value of the comparison feature vector, wherein the first feature value and the second feature value each corresponds to the first feature of the first set of features; is one of a set of contribution scores for the first set of features; and indicates an extent to which the prediction is based on the first feature; determining, by the one or more processors and based at least in part on the set of contribution scores, a subset of features from the first set of features; determining, by the one or more processors, a set of divergent features comprising one or more features of the subset of features, wherein determining the set of divergent features comprises determining to include a first divergent feature in the set of divergent features based at least in part on a difference between the first divergent feature and a second feature satisfying a threshold difference; and determining, by the one or more processors, a bias indicator indicating an extent to which the set of divergent features cause the prediction to differ from one or more predictions associated with different target identifiers, wherein the bias indicator is based at least in part on at least one of the set of divergent features, the difference, or the target bias feature; and initiating, by the one or more processors, a computing action based at least in part on the bias indicator.
Example 2. The computer-implemented method of example 1, wherein the feature vector comprises a target proxy feature and a target domain-related feature, wherein the target proxy feature indicates a predictor associated with the target bias feature, wherein the target domain-related feature is a feature associated with the feature vector that is not the target proxy feature or the target bias feature.
Example 3. The computer-implemented method of any of examples 1 through 2 further comprising: generating the target proxy feature and the target domain-related feature using a machine learning classifier based on the feature vector.
Example 4. The computer-implemented method of any of examples 1 through 3, wherein determining the bias indicator is based at least in part on relative ranking positions of the target bias feature, the target proxy feature, and the target domain-related feature.
Example 5. The computer-implemented method of any of examples 1 through 4, wherein the computing action comprises at least one of: retraining the machine learning model; modifying an output of the machine learning model; or sending data reflective of an alert, automated notification, automated scheduling operation, automated precautionary action, automated security action, or automated data processing action.
Example 6. The computer-implemented method of any of examples 1 through 5, wherein the computing action comprises disabling or retraining the machine learning model based at least in part on determining that the bias indicator satisfies a first criterion.
Example 7. The computer-implemented any of examples 1 through 6 further comprising: generating, by a generative model and based at least in part on the set of divergent features, a statement indicating at least one of a reason for or an extent of bias in the prediction; and at least one of storing or causing display, via a user interface, the statement in association with the prediction.
Example 8. A system comprising: one or more processors; and one or more memories storing processor-executable instructions that, when executed by the one or more processors, cause the one or more processors to perform operations comprising: receiving, by the one or more processors, (i) a target identifier, (ii) a feature vector associated with the target identifier and indicating a first set of feature values for a set of features, (iii) a prediction previously generated by a machine learning model using the feature vector, and (iv) a target bias feature associated with the feature vector; determining, by the one or more processors, a comparison feature vector for the target identifier based at least in part on a distance between a first embedding generated for the feature vector and a second embedding generated for the comparison feature vector; determining, by the one or more processors, a first contribution score for a first feature, wherein the first contribution score: is based at least in part on an amount of change in outputs of the machine learning model when inputs to the machine learning model are changed from a first feature value of a first feature vector to a second feature value of the comparison feature vector, wherein the first feature value and the second feature value each corresponds to the first feature of the first set of features; is one of a set of contribution scores for the first set of features; and indicates an extent to which the prediction is based on the first feature; determining, by the one or more processors and based at least in part on the set of contribution scores, a subset of features from the first set of features; determining, by the one or more processors, a set of divergent features comprising one or more features of the subset of features, wherein determining the set of divergent features comprises determining to include a first divergent feature in the set of divergent features based at least in part on a difference between the first divergent feature and a second feature satisfying a threshold difference; and determining, by the one or more processors, a bias indicator indicating an extent to which the set of divergent features cause the prediction to differ from one or more predictions associated with different target identifiers, wherein the bias indicator is based at least in part on at least one of the set of divergent features, the difference, or the target bias feature; and initiating, by the one or more processors, a computing action based at least in part on the bias indicator.
Example 9. The system of example 8, wherein the feature vector comprises a target proxy feature and a target domain-related feature, wherein the target proxy feature indicates a predictor associated with the target bias feature, wherein the target domain-related feature is a feature associated with the feature vector that is not the target proxy feature or the target bias feature.
Example 10. The system of any of examples 8 through 9 further comprising: generating the target proxy feature and the target domain-related feature using a machine learning classifier based on the feature vector.
Example 11. The system of any of examples 8 through 10, wherein determining the bias indicator is based at least in part on relative ranking positions of the target bias feature, the target proxy feature, and the target domain-related feature.
Example 12. The system of any of examples 8 through 11, wherein the computing action comprises at least one of: retraining the machine learning model; modifying an output of the machine learning model; or sending data reflective of an alert, automated notification, automated scheduling operation, automated precautionary action, automated security action, or automated data processing action.
Example 13. The system of any of examples 8 through 12, wherein the computing action comprises disabling or retraining the machine learning model based at least in part on determining that the bias indicator satisfies a first criterion.
Example 14. The system of any of examples 8 through 13 further comprising: generating, by a generative model and based at least in part on the set of divergent features, a statement indicating at least one of a reason for or an extent of bias in the prediction; and at least one of storing or causing display, via a user interface, the statement in association with the prediction.
Example 15. One or more non-transitory computer-readable media storing processor-executable instructions that, when executed by one or more processors, cause the one or more processors to perform operations comprising: receiving, by the one or more processors, (i) a target identifier, (ii) a feature vector associated with the target identifier and indicating a first set of feature values for a set of features, (iii) a prediction previously generated by a machine learning model using the feature vector, and (iv) a target bias feature associated with the feature vector; determining, by the one or more processors, a comparison feature vector for the target identifier based at least in part on a distance between a first embedding generated for the feature vector and a second embedding generated for the comparison feature vector; determining, by the one or more processors, a first contribution score for a first feature, wherein the first contribution score: is based at least in part on an amount of change in outputs of the machine learning model when inputs to the machine learning model are changed from a first feature value of a first feature vector to a second feature value of the comparison feature vector, wherein the first feature value and the second feature value each corresponds to the first feature of the first set of features; is one of a set of contribution scores for the first set of features; and indicates an extent to which the prediction is based on the first feature; determining, by the one or more processors and based at least in part on the set of contribution scores, a subset of features from the first set of features; determining, by the one or more processors, a set of divergent features comprising one or more features of the subset of features, wherein determining the set of divergent features comprises determining to include a first divergent feature in the set of divergent features based at least in part on a difference between the first divergent feature and a second feature satisfying a threshold difference; and determining, by the one or more processors, a bias indicator indicating an extent to which the set of divergent features cause the prediction to differ from one or more predictions associated with different target identifiers, wherein the bias indicator is based at least in part on at least one of the set of divergent features, the difference, or the target bias feature; and initiating, by the one or more processors, a computing action based at least in part on the bias indicator.
Example 16. The one or more non-transitory computer-readable media of example 15, wherein the feature vector comprises a target proxy feature and a target domain-related feature, wherein the target proxy feature indicates a predictor associated with the target bias feature, wherein the target domain-related feature is a feature associated with the feature vector that is not the target proxy feature or the target bias feature.
Example 17. The one or more non-transitory computer-readable media of any of examples 15 through 16 further comprising: generating the target proxy feature and the target domain-related feature using a machine learning classifier based on the feature vector.
Example 18. The one or more non-transitory computer-readable media of any of examples 15 through 17, wherein determining the bias indicator is based at least in part on relative ranking positions of the target bias feature, the target proxy feature, and the target domain-related feature.
Example 19. The one or more non-transitory computer-readable media of any of examples 15 through 18, wherein the computing action comprises at least one of: retraining the machine learning model; modifying an output of the machine learning model; or sending data reflective of an alert, automated notification, automated scheduling operation, automated precautionary action, automated security action, or automated data processing action.
Example 20. The one or more non-transitory computer-readable media of any of examples 15 through 19, wherein the computing action comprises disabling or retraining the machine learning model based at least in part on determining that the bias indicator satisfies a first criterion.

What is claimed is:

1. A computer-implemented method comprising:
receiving, by one or more processors, (i) a target identifier, (ii) a feature vector associated with the target identifier and indicating a first set of feature values for a set of features, (iii) a prediction previously generated by a machine learning model using the feature vector, and (iv) a target bias feature associated with the feature vector;
determining, by the one or more processors, a comparison feature vector for the target identifier based at least in part on a distance between a first embedding generated for the feature vector and a second embedding generated for the comparison feature vector;
determining, by the one or more processors, a first contribution score for a first feature, wherein the first contribution score:
is based at least in part on an amount of change in outputs of the machine learning model when inputs to the machine learning model are changed from a first feature value of a first feature vector to a second feature value of the comparison feature vector, wherein the first feature value and the second feature value each corresponds to the first feature of the first set of features;
is one of a set of contribution scores for the first set of features; and
indicates an extent to which the prediction is based on the first feature;
determining, by the one or more processors and based at least in part on the set of contribution scores, a subset of features from the first set of features;
determining, by the one or more processors, a set of divergent features comprising one or more features of the subset of features, wherein determining the set of divergent features comprises determining to include a first divergent feature in the set of divergent features based at least in part on a difference between the first divergent feature and a second feature satisfying a threshold difference; and
determining, by the one or more processors, a bias indicator indicating an extent to which the set of divergent features cause the prediction to differ from one or more predictions associated with different target identifiers, wherein the bias indicator is based at least in part on at least one of the set of divergent features, the difference, or the target bias feature; and
initiating, by the one or more processors, a computing action based at least in part on the bias indicator.

2. The computer-implemented method of claim 1, wherein the feature vector comprises a target proxy feature and a target domain-related feature, wherein the target proxy feature indicates a predictor associated with the target bias feature, wherein the target domain-related feature is a feature associated with the feature vector that is not the target proxy feature or the target bias feature.

3. The computer-implemented method of claim 2 further comprising:
generating the target proxy feature and the target domain-related feature using a machine learning classifier based on the feature vector.

4. The computer-implemented method of claim 2, wherein determining the bias indicator is based at least in part on relative ranking positions of the target bias feature, the target proxy feature, and the target domain-related feature.

5. The computer-implemented method of claim 1, wherein the computing action comprises at least one of:
retraining the machine learning model;
modifying an output of the machine learning model; or
sending data reflective of an alert, automated notification, automated scheduling operation, automated precautionary action, automated security action, or automated data processing action.

6. The computer-implemented method of claim 5, wherein the computing action comprises disabling or retraining the machine learning model based at least in part on determining that the bias indicator satisfies a first criterion.

7. The computer-implemented method of claim 1 further comprising:
generating, by a generative model and based at least in part on the set of divergent features, a statement indicating at least one of a reason for or an extent of bias in the prediction; and
at least one of storing or causing display, via a user interface, the statement in association with the prediction.

8. A system comprising:
one or more processors; and
one or more memories storing processor-executable instructions that, when executed by the one or more processors, cause the one or more processors to perform operations comprising:
receiving, by the one or more processors, (i) a target identifier, (ii) a feature vector associated with the target identifier and indicating a first set of feature values for a set of features, (iii) a prediction previously generated by a machine learning model using the feature vector, and (iv) a target bias feature associated with the feature vector;
determining, by the one or more processors, a comparison feature vector for the target identifier based at least in part on a distance between a first embedding generated for the feature vector and a second embedding generated for the comparison feature vector;
determining, by the one or more processors, a first contribution score for a first feature, wherein the first contribution score:
is based at least in part on an amount of change in outputs of the machine learning model when inputs to the machine learning model are changed from a first feature value of a first feature vector to a second feature value of the comparison feature vector, wherein the first feature value and the second feature value each corresponds to the first feature of the first set of features;
is one of a set of contribution scores for the first set of features; and
indicates an extent to which the prediction is based on the first feature;
determining, by the one or more processors and based at least in part on the set of contribution scores, a subset of features from the first set of features;
determining, by the one or more processors, a set of divergent features comprising one or more features of the subset of features, wherein determining the set of divergent features comprises determining to include a first divergent feature in the set of divergent features based at least in part on a difference between the first divergent feature and a second feature satisfying a threshold difference; and
determining, by the one or more processors, a bias indicator indicating an extent to which the set of divergent features cause the prediction to differ from one or more predictions associated with different target identifiers, wherein the bias indicator is based at least in part on at least one of the set of divergent features, the difference, or the target bias feature; and
initiating, by the one or more processors, a computing action based at least in part on the bias indicator.

9. The system of claim 8, wherein the feature vector comprises a target proxy feature and a target domain-related feature, wherein the target proxy feature indicates a predictor associated with the target bias feature, wherein the target domain-related feature is a feature associated with the feature vector that is not the target proxy feature or the target bias feature.

10. The system of claim 9 further comprising:
generating the target proxy feature and the target domain-related feature using a machine learning classifier based on the feature vector.

11. The system of claim 9, wherein determining the bias indicator is based at least in part on relative ranking positions of the target bias feature, the target proxy feature, and the target domain-related feature.

12. The system of claim 8, wherein the computing action comprises at least one of:
retraining the machine learning model;
modifying an output of the machine learning model; or
sending data reflective of an alert, automated notification, automated scheduling operation, automated precautionary action, automated security action, or automated data processing action.

13. The system of claim 12, wherein the computing action comprises disabling or retraining the machine learning model based at least in part on determining that the bias indicator satisfies a first criterion.

14. The system of claim 8 further comprising:
generating, by a generative model and based at least in part on the set of divergent features, a statement indicating at least one of a reason for or an extent of bias in the prediction; and
at least one of storing or causing display, via a user interface, the statement in association with the prediction.

15. One or more non-transitory computer-readable media storing processor-executable instructions that, when executed by one or more processors, cause the one or more processors to perform operations comprising:
receiving, by the one or more processors, (i) a target identifier, (ii) a feature vector associated with the target identifier and indicating a first set of feature values for a set of features, (iii) a prediction previously generated by a machine learning model using the feature vector, and (iv) a target bias feature associated with the feature vector;
determining, by the one or more processors, a comparison feature vector for the target identifier based at least in part on a distance between a first embedding generated for the feature vector and a second embedding generated for the comparison feature vector;
determining, by the one or more processors, a first contribution score for a first feature, wherein the first contribution score:
is based at least in part on an amount of change in outputs of the machine learning model when inputs to the machine learning model are changed from a first feature value of a first feature vector to a second feature value of the comparison feature vector, wherein the first feature value and the second feature value each corresponds to the first feature of the first set of features;
is one of a set of contribution scores for the first set of features; and
indicates an extent to which the prediction is based on the first feature;
determining, by the one or more processors and based at least in part on the set of contribution scores, a subset of features from the first set of features;
determining, by the one or more processors, a set of divergent features comprising one or more features of the subset of features, wherein determining the set of divergent features comprises determining to include a first divergent feature in the set of divergent features based at least in part on a difference between the first divergent feature and a second feature satisfying a threshold difference; and
determining, by the one or more processors, a bias indicator indicating an extent to which the set of divergent features cause the prediction to differ from one or more predictions associated with different target identifiers, wherein the bias indicator is based at least in part on at least one of the set of divergent features, the difference, or the target bias feature; and
initiating, by the one or more processors, a computing action based at least in part on the bias indicator.

16. The one or more non-transitory computer-readable media of claim 15, wherein the feature vector comprises a target proxy feature and a target domain-related feature, wherein the target proxy feature indicates a predictor associated with the target bias feature, wherein the target domain-related feature is a feature associated with the feature vector that is not the target proxy feature or the target bias feature.

17. The one or more non-transitory computer-readable media of claim 16 further comprising:
generating the target proxy feature and the target domain-related feature using a machine learning classifier based on the feature vector.

18. The one or more non-transitory computer-readable media of claim 16, wherein determining the bias indicator is based at least in part on relative ranking positions of the target bias feature, the target proxy feature, and the target domain-related feature.

19. The one or more non-transitory computer-readable media of claim 15, wherein the computing action comprises at least one of:
retraining the machine learning model;
modifying an output of the machine learning model; or
sending data reflective of an alert, automated notification, automated scheduling operation, automated precautionary action, automated security action, or automated data processing action.

20. The one or more non-transitory computer-readable media of claim 19, wherein the computing action comprises disabling or retraining the machine learning model based at least in part on determining that the bias indicator satisfies a first criterion.
